(19) United States
(12) Patent Application Publication
(10) Pub. No.: US 2017/0115631 A1
(43) Pub. Date: Apr. 27, 2017

(54) DISPLAY APPARATUS

(71) Applicant: SAMSUNG DISPLAY CO., LTD., Yongin-si (KR)

(72) Inventors: Junheyung Jung, Yongin-si (KR); Haekwan Seo, Yongin-si (KR)

(21) Appl. No.: 15/273,616

(22) Filed: Sep. 22, 2016

(30) Foreign Application Priority Data
Oct. 27, 2015 (KR) 10-2015-0149732

(51) Int. Cl. G04B 19/04; G04G 9/00

(52) U.S. Cl. CPC G04B 19/04; G04G 9/00; G09G 2300/0426; G09G 2300/04; G09G 2310/08; G09G 3/3225

(57) ABSTRACT

A display apparatus includes a source driver including a first signal output unit at a first side in a first direction and a second signal output unit at a second side in a second direction, a display panel positioned in the first direction from the source driver; at least one first data line for connecting the first signal output unit to the display panel; and at least one second data line for connecting the second signal output unit to the display panel. The at least one second data line extends along an entirety of a surface of the display panel.

### CROSS-REFERENCE TO RELATED APPLICATION

This application claims priority to, and the benefit of, Korean Patent Application No. 10-2015-0149732, filed on Oct. 27, 2015, in the Korean Intellectual Property Office, the disclosure of which is incorporated herein in its entirety by reference.

### BACKGROUND

1. Field

One or more embodiments relate to a display apparatus.

2. Description of the Related Art

A display apparatus includes a display panel in which data lines and pixels connected to the data lines are arranged. The data lines are arranged in the entire display panel to provide data signals to all of the pixels of the display panel.

When the display panel has an area, for example, a groove, a hole, or the like, where the data lines may not be arranged, the data lines have to be arranged through a path that bypasses that area. However, in the case of display apparatuses, such as smart phones and wearable displays that have small sizes, it may be difficult to determine a bypass where data lines are to be arranged.

Information disclosed in this Background section may contain information that does not form the prior art.

### SUMMARY

One or more embodiments include a display apparatus having a connection path via which data lines are connected to all pixels of a display panel, including an area where data lines might not be arranged.

Additional aspects will be set forth in part in the description that follows and, in part, will be apparent from the description, or may be learned by practice of the presented embodiments.

According to one or more embodiments, a display apparatus includes a source driver including a first signal output unit at a first side in a first direction and a second signal output unit at a second side in a second direction, a display panel positioned in the first direction from the source driver, at least one first data line for connecting the first signal output unit to the display panel, and at least one second data line for connecting the second signal output unit to the display panel, wherein the at least one second data extends along an entirety of a surface of the display panel.

A spindle unit may pass through the surface of the display panel. The display panel may include a first display area between the source driver and the spindle unit and a second display area symmetrical to the first display area with respect to the spindle unit.

The at least one first data line may connect the first signal output unit and at least one pixel in the first display area, and the at least one second data line may connect the second signal output unit and at least one pixel in the second display area.

The at least one first data line may be for providing a data signal in the first direction to the at least one pixel in the first display area, and the at least one second data line may be for providing a data signal in a direction opposite to the first direction to the at least one pixel in the second display area.

The first signal output unit may provide a data signal to the at least one pixel in the first display area via the at least one first data line, and the second signal output unit may provide a data signal to the at least one pixel in the second display area via the at least one second data line.

The display panel may be circular, and the spindle unit may pass through a center of the display panel.

The display apparatus may include at least one clock hand connected to the spindle unit and having a length that is less than or equal to a radius of the display panel, and a clock hand controller configured to control movement of the at least one clock hand such that the at least one clock hand rotates around the spindle unit in a clockwise direction.

The source driver may output an identical data signal to corresponding data lines among the at least one first data line and the at least one second data line.

The second direction may be opposite to the first direction.

According to one or more embodiments, a display apparatus includes: a source driver configured to output data signals to a first data line in a first direction and configured to output data signals to a second data line in a second direction, a display panel positioned in the first direction from the source driver, and a spindle unit passing through at least a portion of the display panel, wherein the display panel includes a first display area between the source driver and the spindle unit, and comprising pixels connected to the first data line, and a second display area symmetrical to the first display area with respect to the spindle unit and including pixels connected to the second data line.

The source driver may include a first signal output unit at a first side of the source driver in the first direction and configured to output a data signal via the first data line, and a second signal output unit at a second side of the source driver in the second direction and configured to output a data signal via the second data line.

The second data line may surround at least a portion of a surface of the display panel.

The source driver may output an identical data signal to the first and second data lines.

The display panel may be circular, and the spindle unit may pass through a center of the display panel.

The display apparatus may further include at least one clock hand connected to the spindle unit and having a length less than or equal to a radius of the display panel, and a clock hand controller configured to control movement of the at least one clock hand such that the at least one clock hand rotates around the spindle unit in a clockwise direction.

The second direction may be opposite to the first direction.

### BRIEF DESCRIPTION OF THE DRAWINGS

These and/or other aspects will become apparent and more readily appreciated from the following description of the embodiments, taken in conjunction with the accompanying drawings, in which:

FIG. 1 is a schematic diagram of a display apparatus according to an embodiment;

FIG. 2 is a circuit diagram of an example of a pixel arranged in a display panel;

FIG. 3 is a schematic diagram of a display apparatus according to another embodiment;

FIG. 4 is a schematic diagram of a display apparatus according to another embodiment;

FIG. 5 is a schematic diagram of a display apparatus according to another embodiment; and

FIG. 6 is a schematic diagram of a display apparatus according to another embodiment.

### DETAILED DESCRIPTION

As the inventive concept allows for various changes and numerous embodiments, particular embodiments will be illustrated in the drawings and described in detail in the written description. The attached drawings for illustrating embodiments of the inventive concept are referred to in order to gain a sufficient understanding of the inventive concept, the merits thereof, and the objectives accomplished by the implementation of the inventive concept. The inventive concept may, however, be embodied in many different forms and should not be construed as being limited to the embodiments set forth herein.

Hereinafter, the inventive concept will be described in detail by explaining embodiments of the inventive concept with reference to the attached drawings. Like reference numerals in the drawings denote like elements, and thus their description may be omitted.

It will be understood that, although the terms “first,” “second,” “third,” etc., may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section, without departing from the spirit and scope of the present invention.

Further, it will also be understood that when one element, component, region, layer and/or section is referred to as being “between” two elements, components, regions, layers, and/or sections, it can be the only element, component, region, layer and/or section between the two elements, components, regions, layers, and/or sections, or one or more intervening elements, components, regions, layers, and/or sections may also be present.

The terminology used herein is for the purpose of describing particular embodiments and is not intended to be limiting of the present invention. As used herein, the singular forms “a” and “an” are intended to include the plural forms as well, unless the context clearly indicates otherwise. It will be further understood that the terms “comprise,” “comprises,” “comprising,” “includes,” “including,” and “include,” when used in this specification, specify the presence of stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the present invention refers to “one or more embodiments of the present invention.” Also, the term “exemplary” is intended to refer to an example or illustration.

It will be understood that when an element or layer is referred to as being “on,” “connected to,” “coupled to,” “connected with,” “coupled with,” or “adjacent to” another element or layer, it can be “directly on,” “directly connected to,” “directly coupled to,” “directly connected with,” “directly coupled with,” or “directly adjacent to” the other element or layer, or one or more intervening elements or layers may be present. Furthermore, “connection,” “connected,” etc., may also refer to “electrical connection,” “electrically connected,” etc., depending on the context in which such terms are used as would be understood by those skilled in the art. When an element or layer is referred to as being “directly on,” “directly connected to,” “directly coupled to,” “directly connected with,” “directly coupled with,” or “immediately adjacent to” another element or layer, there are no intervening elements or layers present.

As used herein, “substantially,” “about,” and similar terms are used as terms of approximation and not as terms of degree, and are intended to account for the inherent deviations in measured or calculated values that would be recognized by those of ordinary skill in the art.

As used herein, the terms “use,” “using,” and “used” may be considered synonymous with the terms “utilize,” “utilizing,” and “utilized,” respectively.

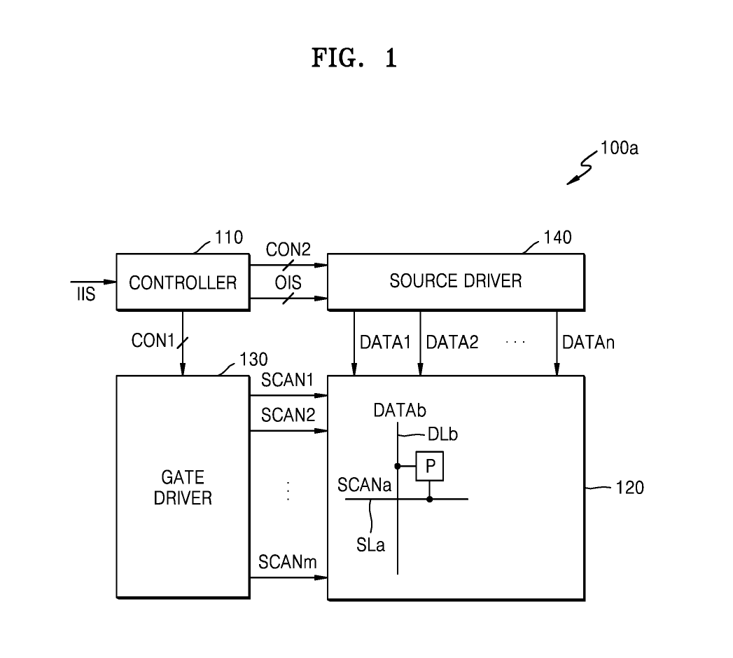

FIG. 1 is a schematic diagram of a display apparatus 100a according to an embodiment.

Referring to FIG. 1, the display apparatus 100a may include a controller 110, a display panel 120, a gate driver 130, and a source driver 140. The controller 110, the gate driver 130, and the source driver 140 may be respectively formed on different semiconductor chips, or may be integrated into a single semiconductor chip. Also, the controller 110, the gate driver 130, and/or the source driver 140 may be formed on the same substrate on which the display panel 120 is formed.

The display apparatus 100a may be a liquid crystal display (LCD) apparatus, an organic light-emitting diode (OLED) display apparatus, a flexible display apparatus, a three-dimensional (3D) display apparatus, an electrophoretic display apparatus, or the like, but the disclosure is not limited thereto. The display apparatus 100a may be an apparatus for providing visual information by emitting light. Hereinafter, a case in which the display apparatus 100a is an OLED display apparatus will be described.

The display apparatus 100a may be an electronic device, such as a wearable display, a smartphone, a tablet personal computer (PC), a laptop computer, a monitor, a TV, or the like.

The display apparatus 100a may display an image via pixels P. The pixel P may include sub-pixels for displaying different colors, such that the display apparatus 100a may display various suitable colors. In the specification, the pixel P may mean a single sub-pixel. However, the disclosure is not limited thereto, and the pixel P may include multiple sub-pixels. That is, one pixel may be understood to be one or more sub-pixels forming one unit pixel.

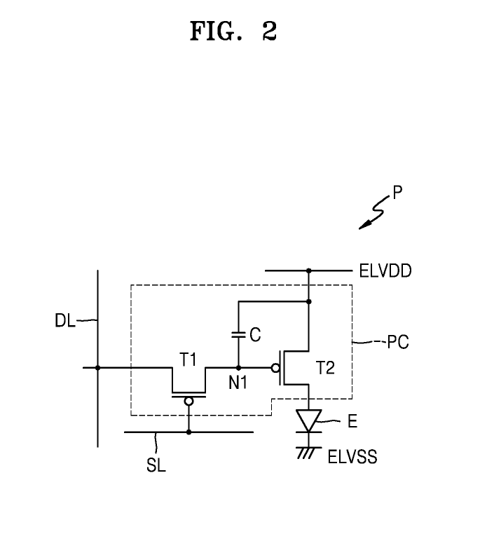

The pixel P may include a light-emitting device E and a pixel circuit PC (see FIG. 2). A driving voltage and a data signal may be applied to the pixel circuit PC, and the pixel circuit PC may output a driving current to the light-emitting device E. The driving voltage may include a first voltage (e.g., a first driving voltage) and a second voltage (e.g., a second driving voltage). The first voltage may have a relatively high level, and the second voltage may have a relatively low level. A level of a driving voltage provided to each pixel P may be a difference between levels of the first and second voltages.

The display apparatus 100a may receive externally supplied image frames. The image frames may display a moving image when the image frames are sequentially displayed. Each image frame may include an input image signal IIS. The input image signal IIS may include information about luminance of light emitted by the pixels P, and the number of bits of the input image signal IIS may be determined according to a level of determined luminance. For example, when the number of levels of luminance of light emitted by the pixels P is 256, the input image signal IIS may be an 8-bit digital signal. When a highest gradient displayed on the display panel 120 is a first level, and when a lowest gradient is a 256^{th} level, an input image signal IIS corresponding to the first level may be 0 (e.g., 00000000), and an input image signal IIS corresponding to the 256^{th} level may be 255 (e.g., 11111111).

The highest gradient that may be displayed on the display panel 120 may be referred to as a small, or minimum, gradient value, and the lowest gradient may be a large, or maximum, gradient value. The number of levels of luminance of light emitted by the pixels P may be 64, 256, 1024, or the like.

Exemplary shapes and operations of the pixels P will be described with reference to FIG. 2. FIG. 2 is a circuit diagram of an example of the pixel P of the display panel.

Referring to FIG. 2, the pixel P may include a light-emitting device E and a pixel circuit PC electrically connected to the light-emitting device E. The light-emitting device E may be an organic light-emitting diode (OLED) device including an anode electrode, a cathode electrode, and a light-emitting layer between the anode and cathode electrodes.

A power voltage provided to the pixel P may include a first power voltage ELVDD and a second power voltage ELVSS. The first power voltage ELVDD may be a voltage having a relatively high level, and the second power voltage ELVSS may be a voltage having a relative low level. A level of the driving voltage provided to each pixel P may be a difference between the levels of the first power voltage ELVDD and the second power voltage ELVSS. For example, when a level of the first power voltage ELVDD is 6 V, and a level of the second power voltage ELVSS is −4 V, a level of the driving voltage provided to the pixel P is 10 V. As the level of the first power voltage ELVDD is relatively high, and as the level of the second power voltage ELVSS is relatively low, the level of the driving voltage provided to each pixel P may be relatively high.

The pixel circuit PC may include two transistors, namely, first and second transistors T1 and T2, and a capacitor C. The first transistor T1 may include a gate electrode connected to a scan line SL, a first electrode connected to a data line DL, and a second electrode connected to a first node N1.

The second transistor T2 may include a gate electrode connected to the first node N1, a first electrode to which the first power voltage ELVDD, from a first power source, is applied, and a second electrode connected to the anode electrode of the light-emitting device E.

The capacitor C may include a first electrode connected to the first node N1 and a second electrode to which the first power voltage ELVDD from the first power source is applied.

The anode electrode of the light-emitting device E is connected to the second electrode of the second transistor T2, and the second power voltage ELVSS may be applied to the cathode electrode thereof.

The first transistor T1 may transmit the data signal, which is provided from a data line DL when a scan signal is provided from the scan line SL, to the first electrode of the capacitor C. Accordingly, a voltage corresponding to the data signal may be charged to the capacitor C, a driving current corresponding to the voltage charged to the capacitor C may be transmitted to the light-emitting device E via the second transistor T2, and thus, the light-emitting device E may emit light.

FIG. 2 shows a structure in which one pixel P includes two transistors and one capacitor, but the disclosure is not limited thereto. Therefore, one pixel may include two or more thin film transistors, and one or more capacitors or may have various suitable structures in which wires are additionally formed, or in which wires are omitted.

Referring back to FIG. 1, the controller 110 may be connected to the display panel 120, the gate driver 130, and the source driver 140. The controller 110 receives the input image signal IIS.

The controller 110 may output first control signals CON1 to the gate driver 130. The first control signals CON1 may include a horizontal synchronization signal. The first control signals CON1 may include control signals that the gate driver 130 uses to output scan signals SCAN1 to SCANm that are synchronized with the horizontal synchronization signal.

The controller 110 may output second control signals CON2 to the source driver 140. The controller 110 may provide an output image signal OIS to the source driver 140. The second control signals CON2 may include control signals that the source driver 140 uses to output data signals DATA1 to DATAn corresponding to the output image signal OIS. The output image signal OIS may include image information for producing the data signals DATA1 to DATAn. The output image signal OIS may be image data that is produced by correcting the input image signal IIS that is received from the outside.

The display panel 120 may include scan lines, which are respectively connected to pixels arranged in a respective row among rows of the pixels, and may include data lines respectively connected to pixels arranged in a respective column among columns of the pixels. For example, as shown in FIG. 1, the display panel 120 may include the pixel P, which may be arranged in an a^{th} row and a b^{th} column of the display panel 120. The display panel 120 may include a scan line Sla connected to all pixels arranged in the a^{th} row, and may include a b data line DLb connected to all pixels arranged in the b^{th} column. The pixel P may be connected to the a scan line SLa and the b data line DLb.

The gate driver 130 may output the scan signals SCAN1 to SCANm to the scan lines, and may do so by synchronizing the scan signals SCAN1 to SCANm with a horizontal synchronization signal.

The source driver 140 may output the data signals DATA1 to DATAn to data lines by respectively synchronizing the data signals DATA1 to DATAn with the scan signals SCAN1 to SCANm. The source driver 140 may output the data signals DATA1 to DATAn, which are in proportion to input image data, to the data lines.

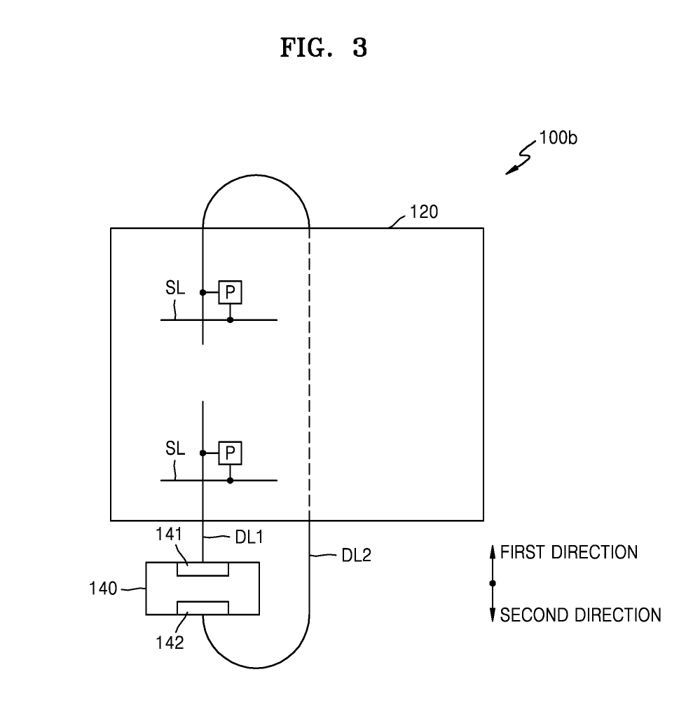

FIG. 3 is a schematic diagram of the display apparatus 100b according to another embodiment.

Referring to FIG. 3, the display apparatus 100b may include the display panel 120, the source driver 140, a first data line DL1, and a second data line DL2. The source driver 140 may include a first signal output unit 141 and a second signal output unit 142. The display apparatus 100b of FIG. 3 is different from the display apparatus 100a of FIG. 1, in that the display apparatus 100b of FIG. 3 further includes some additional components. Hereinafter, a difference between the display apparatus 100a of FIG. 1 and the display apparatus 100b of FIG. 3 will be described.

The source driver 140 may include the first signal output unit 141 on a side in a first direction. That is, as shown in FIG. 3, when the first direction is an up direction, the first signal output unit 141 may be located on a side (e.g., a first side) of the source driver 140 in the first direction. The side may be an edge of the source driver 140. Alternatively, when the source driver 140 has a cubical structure, the side may be a surface in the first direction. The first signal output unit 141 and the display panel 120 face each other, and thus, the first data line DL1 may be connected to the display panel 120 in a straight line from the first signal output unit 141.

The source driver 140 may include a second signal output unit 142 on a side (e.g., a second side) in a second direction that is opposite to the first direction. The second direction may have an angle formed with respect to the first direction of greater than 0 degrees, and may vary. According to an embodiment, the second direction may be a direction opposite to the first direction. That is, as shown in FIG. 3, the second direction may be opposite to the first direction, and may be a down direction. Because the second signal output unit 142 does not face the display panel 120, the second data line DL2 may be connected to the display panel 120 in a curved line from the second signal output unit 142.

The first signal output unit 141 may output the first data signal DATA1 via the first data line DL1, and the second signal output unit 142 may output the second data signal DATA2 via the second data line DL2. The first signal output unit 141 and the second signal output unit 142 might not be physically spaced from other areas of the source driver 140. That is, data lines for transmitting the data signal output from the source driver 140 may be connected to the source driver 140. Areas of the source driver 140 that are respectively connected to the first data line DL1 and the second data line DL2 among the data lines may be the first signal output unit 141 and the second signal output unit 142.

The first data line DL1 may extend to connect the first signal output unit 141 to the display panel 120, and may be connected to some of the pixels P of the display panel 120. The second data line DL2 may extend to connect the second signal output unit 142 to the display panel 120, and may be connected to others of the pixels of the display panel 120.

The second data line DL2 may surround at least a portion of a surface of the display panel 120, or may partially surround a surface of the display panel 120 (e.g., may be on, or may be adjacent, three sides/surfaces/edges of the panel 120). For example, the second data line DL2 may pass underneath, or may pass by, an entire length, width, or height of a first side of the display panel 120, to then curve around to be connected to one or more pixels on a second side of the display panel. In detail, as shown in FIG. 3, the display panel 120 may be in the first direction from the source driver 140. The first data line DL1 may be connected to an edge of the display panel 120 in the second direction (with respect to the display panel 120), and may provide a data signal to the pixels P of the display panel 120 in the first direction. When a surface that is designed to discharge light, which is emitted from the pixels P, is referred to as a front surface, and when a surface opposite to the front surface is referred to as a rear surface, the second data line DL2 may have a curved shape that surrounds the rear surface of the display panel 120, and that may be connected to the edge of the display panel 120 in the first direction. The second data line DL2 may provide a data signal to the pixels P of the display panel 120 in the second direction. When lines arranged at the rear surface of the display panel 120 are used, and when the display panel 120 may include an area where lines are not arranged, lines may be arranged in areas of the display panel 120 except for the area where lines are not arranged.

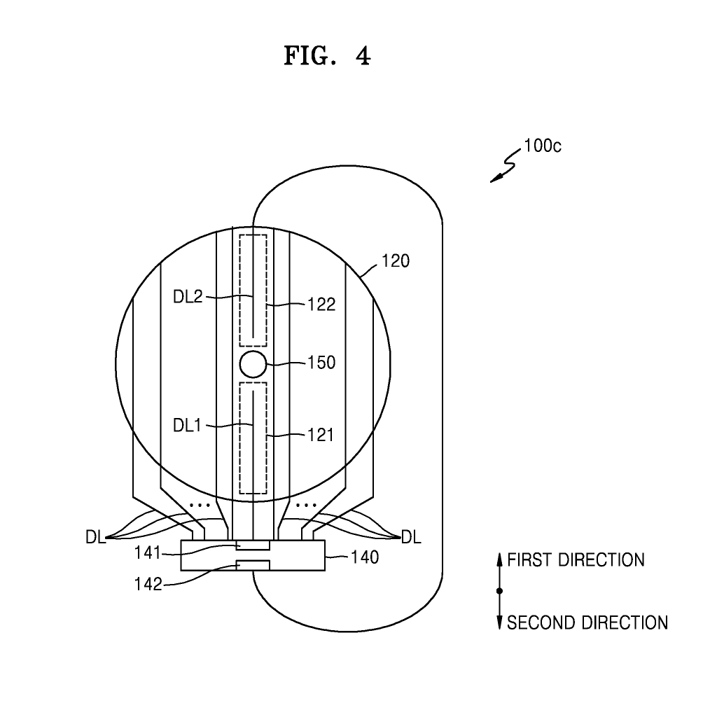

FIG. 4 is a schematic diagram of the display apparatus 100c according to another embodiment.

Referring to FIG. 4, the display apparatus 100c may include the display panel 120, the source driver 140, the data lines, and a spindle unit 150. The data lines may include the first data line DL1 and the second data line DL2. The display apparatus 100c of FIG. 4 is different from the display apparatus 100b of FIG. 3 in that the display apparatus 100c of FIG. 4 further includes some additional components. Hereinafter, a difference between the display apparatuses 100b of FIG. 3 and the display apparatuses 100c of FIG. 4 will be described.

The display apparatus 100c may include the spindle unit 150 that passes through at least a portion of the display panel 120. The spindle unit 150 may be arranged at various suitable locations within the display panel 120. For example, as shown in FIG. 4, the display panel 120 may be a circular display panel including the spindle unit 150 at a center thereof.

Also, one display apparatus 100c may include multiple spindle units 150. For example, the display apparatus 100c may include a first spindle unit that passes through at least a portion of a first area of the display panel 120, and may include a second spindle unit that passes through a portion of a second area of the display panel 120.

The spindle unit 150 may completely pass through the display panel 120, or may pass through a portion of the display panel 120. For example, the display panel 120 may include layers produced through one or more deposition and/or etching processes. The spindle unit 150 may pass through all of the layers of the display panel 120. The display panel 120 may have/define a hole. As another example, the spindle unit 150 may pass through some of the layers of the display panel 120. The display panel 120 may have/define a groove.

Lines, such as the data lines and/or the like, might not be arranged where the spindle unit 150 is located. That is, as shown in FIG. 4, the first data line DL1, which extends from the first signal output unit 141 of the source driver 140 to the inside of the display panel 120, might not extend over the spindle unit 150 in a straight line. Also, it may be difficult to design the first data line DL1 to bypass the location where the spindle unit 150 exists in a curved line due to a lack of space where lines are to be arranged, which may be due to miniaturization and high-resolution of the display apparatus 100c, may be due to interference between lines that may be caused when distances between the lines are too small, and/or may be due to a difficulty level and/or costs of a process design, or the like. Therefore, in the areas where the lines are not arranged in a straight line due to the spindle unit 150, a data signal may be provided via a data line other than the first data line DL1.

The display panel 120 may include a first display area 121, which is defined between the source driver 140 and the spindle unit 150, and may include a second display area 122, which is defined on a location that is symmetrical to the first display area 121 with respect to the spindle unit 150. Pixels P arranged in the first display area 121 may receive data signals via the first data line DL1 connected to the source driver 140 in a straight line. Pixels P arranged in the second display area 122 may not receive data signals from the data lines that are connected to the source driver 140 in a straight line in the first direction. Therefore, as shown in FIG. 3, the pixels P of the second display area 122 may surround, or may be at, the rear surface of the display panel 120 in a curved line, and the data signals may be applied to the pixels P via the second data line DL2 that may be connected to an edge of the display panel 120 in the first direction.

The first display area 121 and the second display area 122 might not be distinguished from each other based on a difference in physical properties on the display panel 120, and may be areas arranged on side surfaces of the display panel 120 for convenience. However, the second data line DL2 may be arranged to surround, or pass/extend along an entirety of, the rear surface of the display panel 120 of the display apparatus 100c.

Also, the scan lines, which connect the gate driver 130 to each pixel P of the display panel 120, may each include an area where the pixels P are not connected to the gate driver 130 in a straight line due to the spindle unit 150. Scan signals may be provided to all of the pixels P of the display panel 120 via some of the scan lines that surround the rear surface of the display panel 120 (e.g., are adjacent the rear surface of the display panel 120, and adjacent two edges of the display panel 120 at opposite ends of the rear surface).

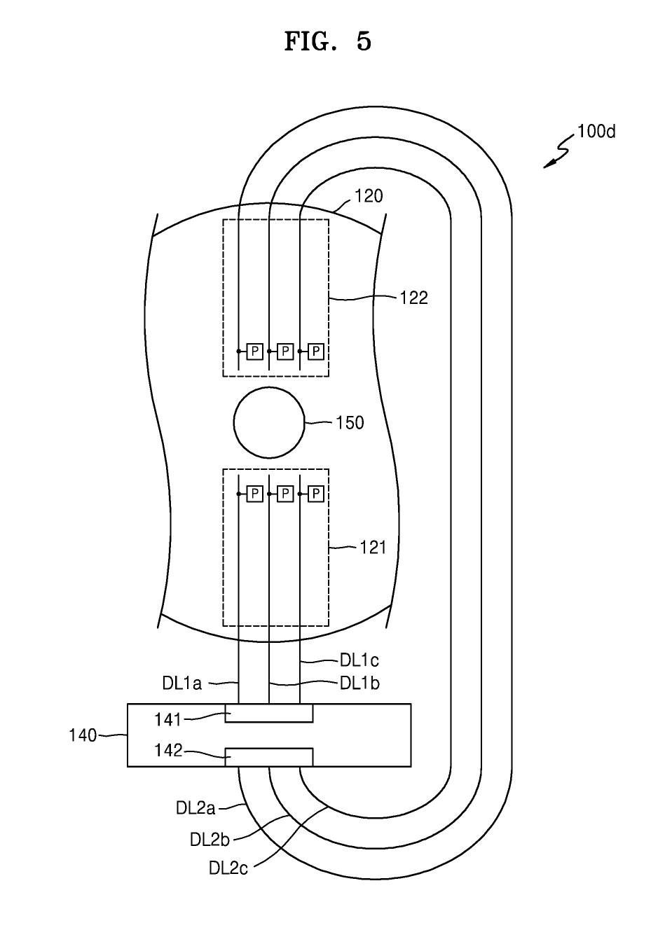

The display apparatus 100c may include multiple spindle units 150. The source driver 140 may provide the data signals to the pixels P, which are respectively arranged in areas where lines are not arranged in straight lines due to obstruction by the spindle units 150, via the data lines that surround, or partially surround, the rear surface of the display panel 120 in a curved shape. The first data line DL1 and the second data line DL2 may each represent a collection of data lines. Relations between data lines will be described with reference to FIG. 5.

FIG. 5 is a schematic diagram of the display apparatus 100c according to another embodiment.

Referring to FIG. 5, the display apparatus 100d may include the display panel 120, the source driver 140, the data lines, and the spindle unit 150.

The data lines may include first data lines DL1 and second data lines DL2. The display apparatus 100d of FIG. 5 is different from the display apparatuses 100c of FIG. 4 in that the display apparatus 100d of FIG. 5 further includes some additional components. Hereinafter, a difference between the display apparatus 100c of FIG. 4 and the display apparatuses 100d of FIG. 5 will be described.

The first data lines DL1 may include a 1a data line DL1a, a 1b data line DL1b, and a 1c data line DL1c. The second data lines DL2 may include a 2a data line DL2a, a 2b data line DL2b, and a 2c data line DL2c. The 1a data line DL1a may provide a data signal to a pixel P included in the first display area 121. The 2a data line DL2a may be arranged in the same column in which the pixel P receiving the data signal from the 1a data line DL1a is arranged, and may provide a data signal to a pixel P included in the second display area 122. Similarly, the 1b data line DL1b and the 2b data line DL2b may provide data signals to pixels P that are arranged in the same column as described above, and the 1c data line DL1c and the 2c data line DL2c may also provide data signals to pixels P that are arranged in the same column as described above.

Identical data signals may be provided to data lines corresponding to each other among the first and second data lines DL1 and DL2. For example, identical data signals may be provided to the first and second data lines DL1 and DL2 providing the data signals to pixels P arranged in the same column. That is, identical data signals may be provided to the 1a data line DL1a and the 2a data line DL2a, identical data signals may be provided to the 1b data line DL1b and the 2b data line DL2b, and identical data signals may be provided to the 1c data line DL1c and the 2c data line DL2c. To this end, the data signal provided by the first signal output unit 141 via the 1a data line DL1a may be the same as the data signal provided by the second signal output unit 142 via the 2a data line DL2a. Similarly, the data signal provided by the first signal output unit 141 via the 1b data line DL1b may be the same as the data signal provided by the second signal output unit 142 via the 2b data line DL2b, and the data signal provided by the first signal output unit 141 via the 1c data line DL1c may be the same as the data signal provided by the second signal output unit 142 via the 2c data line DL2c.

In detail, when an area of the display panel 120 is not affected by the spindle unit 150, data signals are generally provided to pixel circuits PC of the pixels P arranged in the same column via one data line DL. The scan signal determines which of the data signals is provided to which pixel circuit PC of a pixel P among the pixels in the same column. Therefore, two data lines arranged in the same column among columns of the first data lines DL1 and the second data lines DL2 may receive data signals in the same manner as the manner that the pixels P arranged in the area that is not affected by the spindle unit 150 receive the data signal.

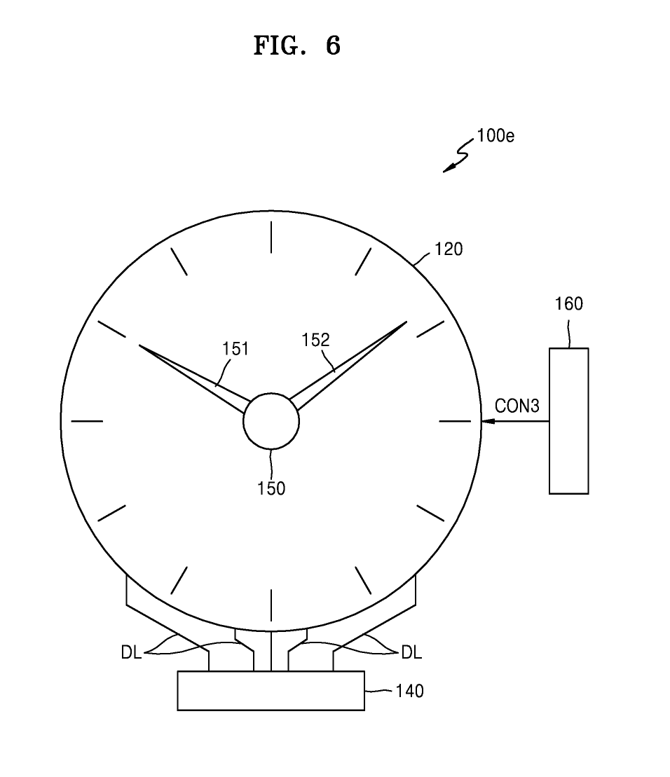

FIG. 6 is a schematic diagram of the display apparatus 100d according to another embodiment.

Referring to FIG. 6, the display apparatus 100e may include the display panel 120, the source driver 140, the spindle unit 150, clock hands 151 and 152, and a clock hand controller 160. The display apparatus 100e of FIG. 6 is different from the display apparatus 100c of FIG. 4 and the display apparatuses 100d of FIG. 5 in that the display apparatus 100e of FIG. 6 further includes some additional components. Hereinafter, a difference between the display apparatuses of FIGS. 4 to 6 (100c, 100d, 100e) will be described.

The display apparatus 100e may be a circular display apparatus, and the display panel 120 may be a circular display panel. For example, the display apparatus 100e may be a watch-type wearable display apparatus that may be worn by a user, and the display panel 120 may be a circular display panel that displays various suitable pieces of information through the watch-type wearable display apparatus. The spindle unit 150 may be arranged on a central portion of the display panel 120 or on a location of an inner surface of the display panel 120.

The clock hands 151 and 152 may be line segments having certain lengths. An end portion of each of the clock hands 151 and 152 may be fixed to the spindle unit 150, and the other end thereof may indicate the outside of the display panel 120. The lengths of the clock hands 151 and 152 may be smaller than, or the same as, a radius of the display panel 120. FIG. 6 illustrates two clock hands, that is, the clock hands 151 and 152, but the disclosure is not limited thereto. That is, the display apparatus 100e may include one clock hand, or may include three clock hands or more. Also, each of the clock hands 151 and 152 may be fixed to the same spindle unit 150 or may be fixed to different spindle units 150.

The clock hands 151 and 152 may rotate in parallel to the front surface of the display panel 120 with respect to the end portions of the clock hands 151 and 152. The clock hand controller 160 may control movements of the clock hands 151 and 152, such that the clock hands 151 and 152 may indicate information intended by a manufacturer or by a user of the display apparatus 100e. The clock hand controller 160 may control the movements of the clock hands 151 and 152 by outputting a third control signal CON3 to at least one of the controller 110, the display panel 120, the spindle unit 150, and the clock hands 151 and 152.

According to one or more embodiments, there may be provided a display apparatus 100e including a display panel 120 for displaying electronic information, pixels P of the display panel 120, and analog clock hands 151 and 152. When the display apparatus 100e is provided, a spindle unit 150 exists within the display panel 120 in order to fix the analog clock hands 151 and 152 to the spindle unit 150, and data signals might not be properly provided to the pixels of the display panel 120. Accordingly, the display apparatus 100e may allow data lines to be connected to all of the pixels P of the display panel 120 by setting the data lines to have at least one interval therebetween, and may provide the data signals to all of the pixels P without any interference between the data lines DL.

According to one or more embodiments, when a display panel has an area where data lines may not be arranged, the display panel may have a connection path via which the data lines may be connected to pixels of the display panel. Therefore, data signals may be properly provided by a display apparatus including the display panel having the area where the data lines may not be arranged.

The steps of all methods described herein can be performed in any suitable order unless otherwise indicated herein or otherwise clearly contradicted by context. The inventive concept is not limited to the described order of the steps. The use of any and all examples, or exemplary language (e.g., “such as”) provided herein, is intended merely to better illuminate the inventive concept and does not pose a limitation on the scope of the inventive concept unless otherwise claimed. Numerous modifications and adaptations will be readily apparent to those skilled in this art without departing from the spirit and scope of the inventive concept.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims and their equivalents.

What is claimed is:

1. A display apparatus comprising:
a source driver comprising:
a first signal output unit at a first side in a first direction; and
a second signal output unit at a second side in a second direction;
a display panel positioned in the first direction from the source driver;
at least one first data line for connecting the first signal output unit to the display panel; and
at least one second data line for connecting the second signal output unit to the display panel,
wherein the at least one second data line extends along an entirety of a surface of the display panel.

2. The display apparatus of claim 1, further comprising a spindle unit that passes through the surface of the display panel,
wherein the display panel comprises:
a first display area between the source driver and the spindle unit; and
a second display area symmetrical to the first display area with respect to the spindle unit.

3. The display apparatus of claim 2, wherein the at least one first data line connects the first signal output unit and at least one pixel in the first display area, and
wherein the at least one second data line connects the second signal output unit and at least one pixel in the second display area.

4. The display apparatus of claim 3, wherein the at least one first data line is for providing a data signal in the first direction to the at least one pixel in the first display area, and
wherein the at least one second data line is for providing a data signal in a direction opposite to the first direction to the at least one pixel in the second display area.

5. The display apparatus of claim 3, wherein the first signal output unit is configured to provide a data signal to the at least one pixel in the first display area via the at least one first data line, and
wherein the second signal output unit is configured to provide a data signal to the at least one pixel in the second display area via the at least one second data line.

6. The display apparatus of claim 2, wherein the display panel is circular, and
wherein the spindle unit passes through a center of the display panel.

7. The display apparatus of claim 6, further comprising:
at least one clock hand connected to the spindle unit, and having a length that is less than or equal to a radius of the display panel, and
a clock hand controller configured to control movement of the at least one clock hand such that the at least one clock hand rotates around the spindle unit in a clockwise direction.

8. The display apparatus of claim 1, wherein the source driver is configured to output an identical data signal to corresponding data lines among the at least one first data line and the at least one second data line.

9. The display apparatus of claim 1, wherein the second direction is opposite to the first direction.

10. A display apparatus comprising:
a source driver configured to output data signals to a first data line in a first direction, and configured to output data signals to a second data line in a second direction that is opposite to the first direction;
a display panel positioned in the first direction from the source driver; and
a spindle unit passing through at least a portion of the display panel,
wherein the display panel comprises:
a first display area between the source driver and the spindle unit, and comprising pixels connected to the first data line; and
a second display area symmetrical to the first display area with respect to the spindle unit, and comprising pixels connected to the second data line.

11. The display apparatus of claim 10, wherein the source driver comprises:
a first signal output unit at a first side of the source driver in the first direction, and configured to output a data signal via the first data line; and
a second signal output unit at a second side of the source driver in the second direction, and configured to output a data signal via the second data line.

12. The display apparatus of claim 10, wherein the second data line surrounds at least a portion of a surface of the display panel.

13. The display apparatus of claim 10, wherein the source driver is configured to output an identical data signal to the first and second data lines.

14. The display apparatus of claim 10, wherein the display panel is circular, and
wherein the spindle unit passes through a center of the display panel.

15. The display apparatus of claim 14, further comprising:
at least one clock hand connected to the spindle unit, and having a length less than or equal to a radius of the display panel; and
a clock hand controller configured to control movement of the at least one clock hand such that the at least one clock hand rotates around the spindle unit in a clockwise direction.

16. The display apparatus of claim 10, wherein the second direction is opposite to the first direction.
